(19) United States
(12) Patent Application Publication
(10) Pub. No.: US 2026/0025854 A1
(43) Pub. Date: Jan. 22, 2026

(54) CHANNEL USAGE PROCEDURES

(71) Applicant: Samsung Electronics Co., Ltd., Suwon-si (KR)

(72) Inventors: Rubayet Shafin, Allen, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 19/258,772

(22) Filed: Jul. 2, 2025

Related U.S. Application Data
(60) Provisional application No. 63/672,511, filed on Jul. 17, 2024.

(51) Int. Cl. H04W 74/0816; H04W 52/02; H04W 76/14; H04W 88/08

(52) U.S. Cl. CPC H04W 74/0816; H04W 52/0261; H04W 76/14; H04W 88/08

(57) ABSTRACT

An access point (AP) for facilitating communication in a wireless network. The AP receives, from a non-AP station (STA) associated with the AP, a channel usage request frame requesting to establish a peer-to-peer (P2P) target wake time (TWT) agreement. The channel usage request frame indicating the non-AP STA's unavailability during the P2P TWT agreement. The AP transmits, to the non-AP STA, a channel usage response frame accepting the request to establish a P2P TWT agreement. The AP determines that the non-AP STA is in a power save mode and in a doze state at a start of a P2P service period associated with the P2P TWT agreement and the non-AP STA transitions back to a power management mode that the non-AP STA had before entering the P2P service period.

### CROSS REFERENCE TO RELATED APPLICATION

This application claims benefit of U.S. Provisional Application No. 63/672,511, entitled “PROCEDURES FOR CHANNEL USAGE,” filed on Jul. 17, 2024, in the United States Patent and Trademark Office, which is hereby incorporated by reference in its entirety.

### TECHNICAL FIELD

This disclosure relates generally to a wireless communication system, and more particularly to, for example, but not limited to, a peer-to-peer target wake time (TWT) indicating unavailability in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol for establishing an unavailability schedule or peer-to-peer (P2P) target wake time (TWT) schedule by a station (STA) with an access point (AP) associated with the STA.

An aspect of the disclosure provides an AP for facilitating communication in a wireless network. The AP comprises a memory and a processor coupled to the memory. The processor is configured to cause receiving, from a non-AP STA associated with the AP, a channel usage request frame requesting to establish a P2P TWT agreement. The channel usage request frame indicates the non-AP STA's unavailability during the P2P TWT agreement. The processor is further configured to cause transmitting, to the non-AP STA, a channel usage response frame accepting the request to establish a P2P TWT agreement. The processor is further configured to cause determining that the non-AP STA is in a power save mode and in a doze state at a start of a P2P service period associated with the P2P TWT agreement and the non-AP STA transitions back to a power management mode that the non-AP STA had before entering the P2P service period.

In an embodiment, the processor is further configured to cause receiving, from the non-AP STA, a frame that is addressed to the AP within a time that overlaps with the P2P TWT service period. The processor is further configured to cause determining a power management mode and a power state of the non-AP STA for a remaining portion of the P2P TWT service period based on information carried in the frame.

In an embodiment, the channel usage request frame includes a usage mode field in a channel usage element. The usage mode field indicates the non-AP STA's unavailability during the P2P TWT agreement.

In an embodiment, the channel usage response frame includes a usage mode field in a channel usage element. The usage mode field indicates the non-AP STA's unavailability during the P2P TWT agreement.

In an embodiment, a value for a TWT flow identifier field in a TWT element in the channel usage response frame is different from a value of a TWT flow identifier field in a TWT element in the channel usage request frame. Each TWT flow identifier field indicates information to identify the P2P TWT agreement.

In an embodiment, a value for a TWT flow identifier field in a TWT element in the channel usage response frame is different from a value of a TWT flow identifier field in a TWT element in the channel usage request frame. Each TWT flow identifier field indicates information to identify a different P2P TWT agreement.

In an embodiment, a value for a TWT flow identifier field in a TWT element in the channel usage response frame is the same as a value of a TWT flow identifier field in a TWT element in the channel usage request frame. Each TWT flow identifier field indicates information to identify the P2P TWT agreement.

In an embodiment, the processor is further configured to cause abstaining from transmitting a TWT teardown frame to a non-AP STA requesting to delete the P2P TWT agreement.

In an embodiment, the processor is further configured to cause abstaining from transmitting a TWT information frame to a non-AP STA requesting to suspend or resume the P2P TWT agreement.

In an embodiment, the P2P TWT agreement is an individual TWT agreement. A number of individual TWT agreements established between the AP and the non-AP STA is not greater than a value indicated by a TWT flow identifier field in a TWT element in the channel usage request frame or the channel usage response frame.

An aspect of the disclosure provides a non-AP STA for facilitating communication in a wireless network. The non-AP STA comprises a memory and a processor coupled to the memory. The processor is configured to cause transmitting, to an AP associated with the non-AP STA, a channel usage request frame requesting to establish a P2P TWT agreement. The channel usage request frame indicating the non-AP STA's unavailability during the P2P TWT agreement. The processor is further configured to cause receiving, from the AP, a channel usage response frame accepting the request to establish a P2P TWT agreement. The processor is further configured to cause entering a P2P service period associated with the P2P TWT agreement in a power save mode and in a doze state. The processor is further configured to cause transitioning back to a power management mode that the non-AP STA had before entering the P2P service period.

In an embodiment, the processor is further configured to cause transmitting, to the AP, a frame that is addressed to the AP within a time that overlaps with the P2P TWT service period. The processor is further configured to cause transitioning to a power management mode and a power state for a remaining portion of the P2P TWT service period.

In an embodiment, the channel usage request frame includes a usage mode field in a channel usage element. The usage mode field indicates the non-AP STA's unavailability during the P2P TWT agreement.

In an embodiment, the channel usage response frame includes a usage mode field in a channel usage element. The usage mode field indicates the non-AP STA's unavailability during the P2P TWT agreement.

In an embodiment, a value for a TWT flow identifier field in a TWT element in the channel usage response frame is different from a value of a TWT flow identifier field in a TWT element in the channel usage request frame. Each TWT flow identifier field indicates information to identify the P2P TWT agreement.

In an embodiment, a value for a TWT flow identifier field in a TWT element in the channel usage response frame is different from a value of a TWT flow identifier field in a TWT element in the channel usage request frame. Each TWT flow identifier field indicates information to identify a different P2P TWT agreement.

In an embodiment, a value for a TWT flow identifier field in a TWT element in the channel usage response frame is the same as a value of a TWT flow identifier field in a TWT element in the channel usage request frame. Each TWT flow identifier field indicates information to identify the P2P TWT agreement.

In an embodiment, the processor is further configured to cause abstaining from transmitting a TWT teardown frame to a non-AP STA requesting to delete the P2P TWT agreement.

In an embodiment, the processor is further configured to cause abstaining from transmitting a TWT information frame to a non-AP STA requesting to suspend or resume the P2P TWT agreement.

In an embodiment, the P2P TWT agreement is an individual TWT agreement. A number of individual TWT agreements established between the AP and the non-AP STA is not greater than a value indicated by a TWT flow identifier field in a TWT element in the channel usage request frame or the channel usage response frame.

### BRIEF DESCRIPTION OF THE DRAWINGS

FIG. 1 illustrates an example of a wireless network in accordance with an embodiment of this disclosure.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example unavailability indication in accordance with an embodiment.

FIG. 6 shows another example unavailability indication in accordance with an embodiment.

FIG. 7 shows an example unavailability schedule in accordance with an embodiment.

FIG. 8 shows an example channel usage setup communication in accordance with an embodiment.

FIG. 9 shows an example power management mode before and after P2P TWT SP in accordance with an embodiment.

FIG. 10 shows an example power saving state change in accordance with an embodiment.

FIG. 11 shows an example format of the TWT element in accordance with an embodiment.

FIG. 12 shows another example channel usage setup communication in accordance with an embodiment.

FIG. 13 shows an example process for indicating unavailability in accordance with an embodiment.

FIG. 14 shows another example process for indicating unavailability in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

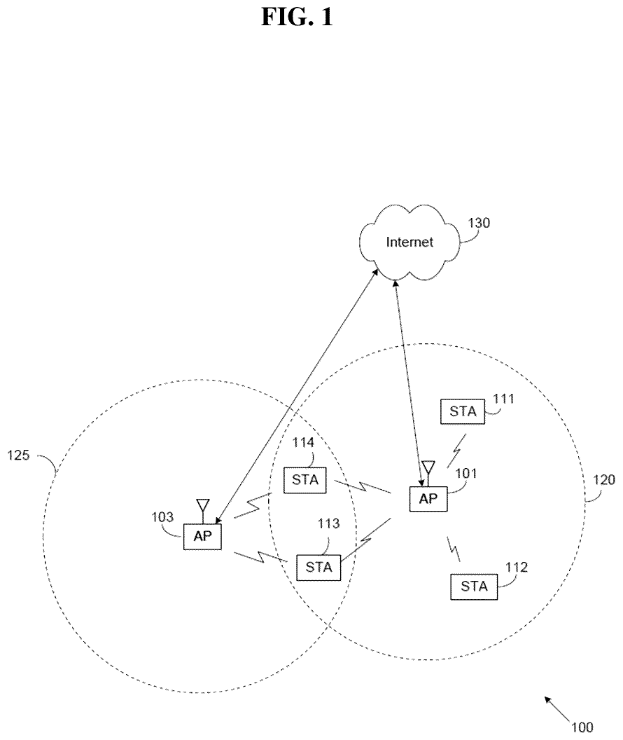

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of multiple user (MU)-MIMO and orthogonal frequency division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

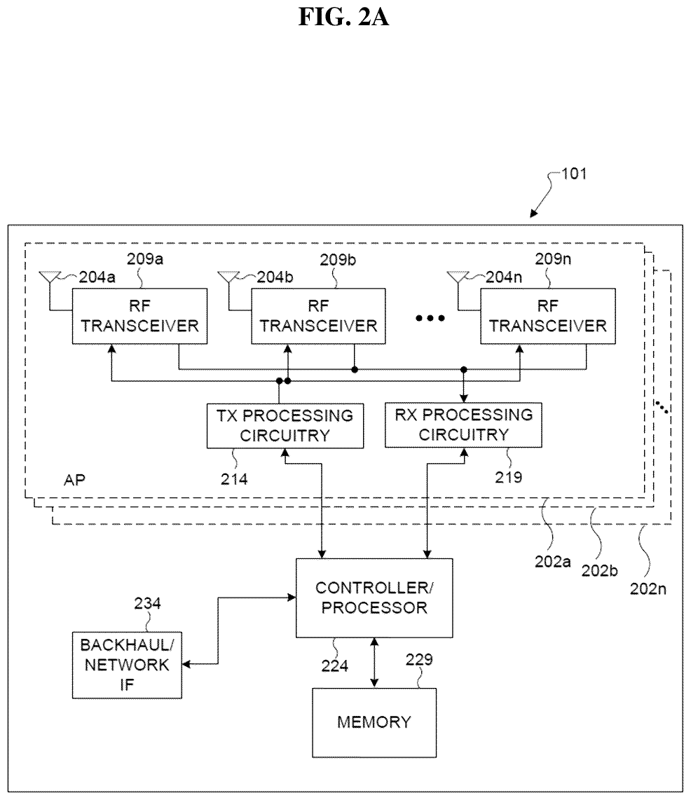

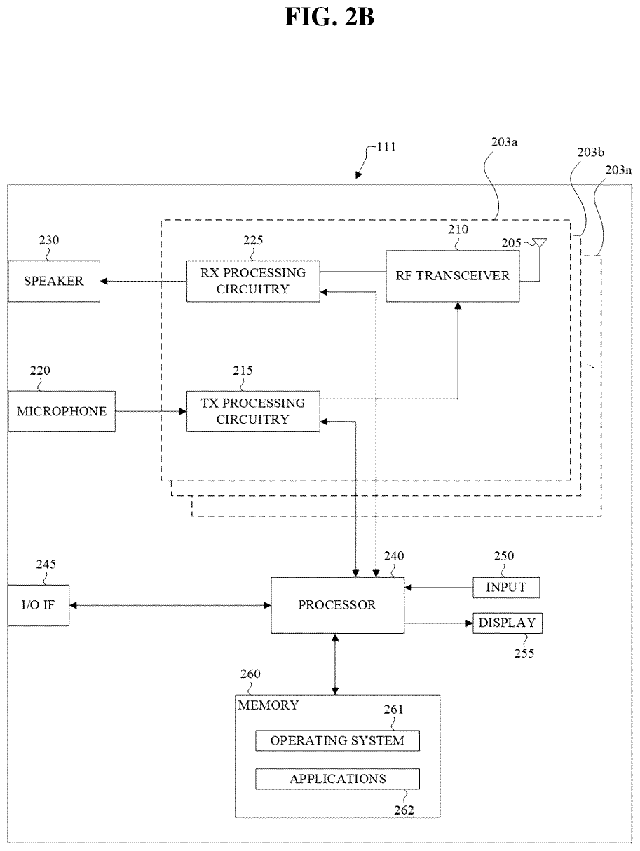

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

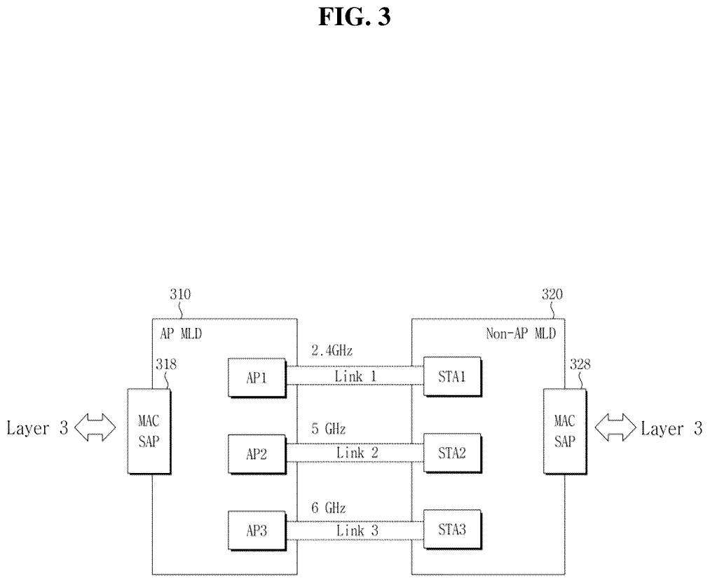

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” iii) IEEE P802.11be/D6.0, “Wireless LAN Medium Access Control (MAC) and Physical Layer (PHY) Specifications,” and iv) IEEE P802.11 REVme Draft D6.0 “Part 11: Wireless LAN Medium Access Control (MAC) and Physical Layer (PHY) Specifications.”

Next generation WLAN system needs to provide better support for low-latency applications. Today it is not uncommon to observe numerous devices operating on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

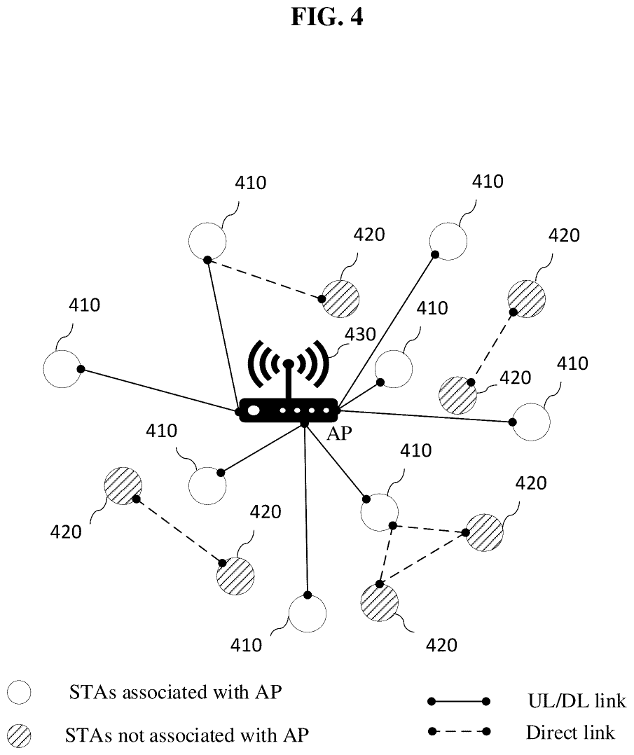

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

An unavailability indication can be made when a first non-AP STA can indicate, to an AP associated with the first non-AP STA, a sequence of time periods, such as service periods (SPs), during which the first non-AP STA will be unavailable for frame exchanges with the AP. The first non-AP STA may be involved in peer-to-peer (P2P) communication with a second non-AP STA during the unavailability of the first non-AP STA.

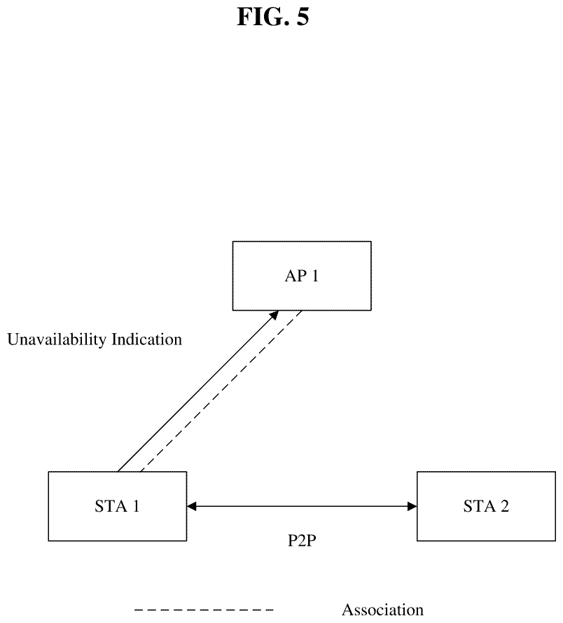

FIG. 5 shows an example unavailability indication in accordance with an embodiment. The example depicted in FIG. 5 is for explanatory and illustration purposes. FIG. 5 does not limit the scope of this disclosure to any particular implementation.

Referring to FIG. 5, an AP 1 is associated with an STA 1. The AP 1 is not associated with an STA 2. The STA 1 and the STA 2 share a direct P2P link. The STA 1 transmits, to the AP 1, a frame including an unavailability indication. The STA 1 may be unavailable due to P2P communication with the STA 2.

An unavailability indication can also be made where the first non-AP STA may be involved in a scheduled coexistence event with a second STA during the unavailability of the first non-AP STA.

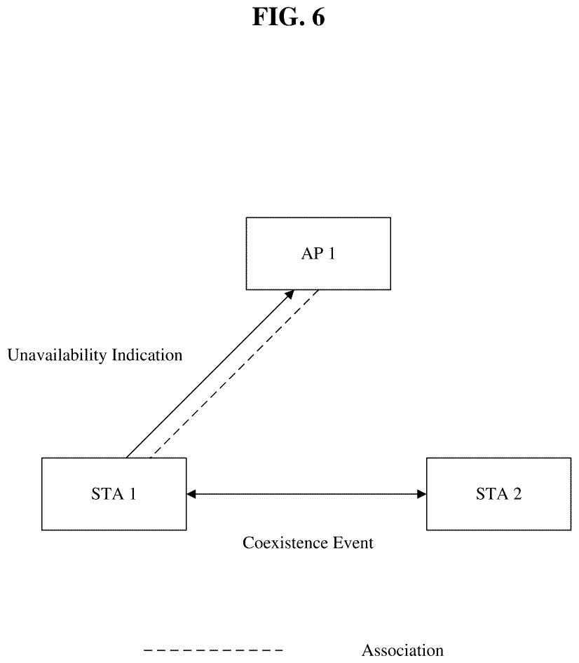

FIG. 6 shows another example unavailability indication in accordance with an embodiment. The example depicted in FIG. 6 is for explanatory and illustration purposes. FIG. 6 does not limit the scope of this disclosure to any particular implementation.

Referring to FIG. 6, an AP 1 is associated with an STA 1. The AP 1 is associated with an STA 2. The STA 1 has a coexistence event with the STA 2. The STA 1 transmits, to the AP 1, a frame including an unavailability indication. The STA 2 may be unavailable due to coexistence event with the STA 2.

The baseline spec provides a scenario where a non-AP STA has set up an unavailability schedule or a P2P TWT schedule with its associated AP. In this scenario, the non-AP STA does not have a mechanism to change the parameters of the unavailability SP or the unavailability P2P TWT SPs.

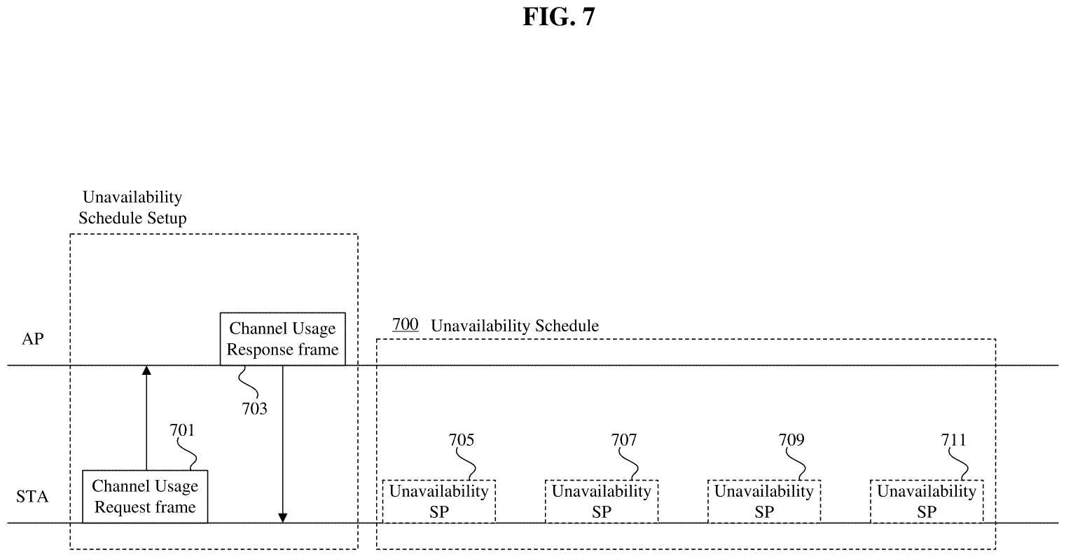

FIG. 7 shows an example unavailability schedule 700 in accordance with an embodiment. The example depicted in FIG. 7 is for explanatory and illustration purposes. FIG. 7 does not limit the scope of this disclosure to any particular implementation.

Referring to FIG. 7, an AP is associated with an STA. The STA transmits, to the AP, a channel usage request frame 701 including a TWT elements field. The TWT elements field may include a TWT schedule 700 during which the STA expects to be unavailable. In response, the AP transmits, to the STA, a channel usage response frame 703 accepting the request of the channel usage request frame 701. The STA and the AP successfully complete unavailability schedule setup. Subsequently, the STA is periodically unavailable for frame exchanges with the AP during SPs of the TWT schedule 700 identified in the TWT elements field. In this examples, these SPs include the unavailability SPs 705, 707, 709 and 711.

In FIG. 7, some problems exist that the disclosure addresses. The first problem is that there is no guidance for the behavior of an AP or non-AP STA on what to do after the lifetime of a P2P TWT schedule ends. The second problem is that there is no guidance on a power saving state during and after a P2P TWT SP. The third problem is that there is no guidance on the value of a TWT flow identifier field in the channel usage request and response frame.

In an embodiment, a non-AP STA transmits a channel request frame to an AP associated with the non-AP STA to establish a P2P TWT schedule with the AP to indicate unavailability of the non-AP STA. The non-AP STA can include a usage mode field in a channel usage element included in the channel usage request frame and can set a value of the usage mode field to 0, 1 or 3. The usage mode field identifies a usage of recommended channels listed in an operating class/channel number pair fields. In an implementation, a usage mode field value of 0 indicates a channel-usage-aidable BSS. A usage mode field value of 1 indicates an off-channel tunneled direct link setup (TDLS) direct link. A usage mode field value of 3 indicates an unavailability of the non-AP STA.

In an embodiment, in response to a non-AP STA transmitting a channel request frame to an AP associated with the non-AP STA to establish a P2P TWT schedule with the AP to indicate unavailability of the non-AP STA, the AP can transmit a channel usage response frame. This results in a P2P TWT agreement. The AP can include a usage mode field in a channel usage element included in the channel usage response frame and can set a value of the usage mode field to 0, 1 or 3. The usage mode field identifies a usage of recommended channels listed in an operating class/channel number pair fields. In an implementation, a usage mode field value of 0 indicates a channel-usage-aidable BSS. A usage mode field value of 1 indicates an off-channel TDLS direct link. A usage mode field value of 3 indicates an unavailability of the non-AP STA.

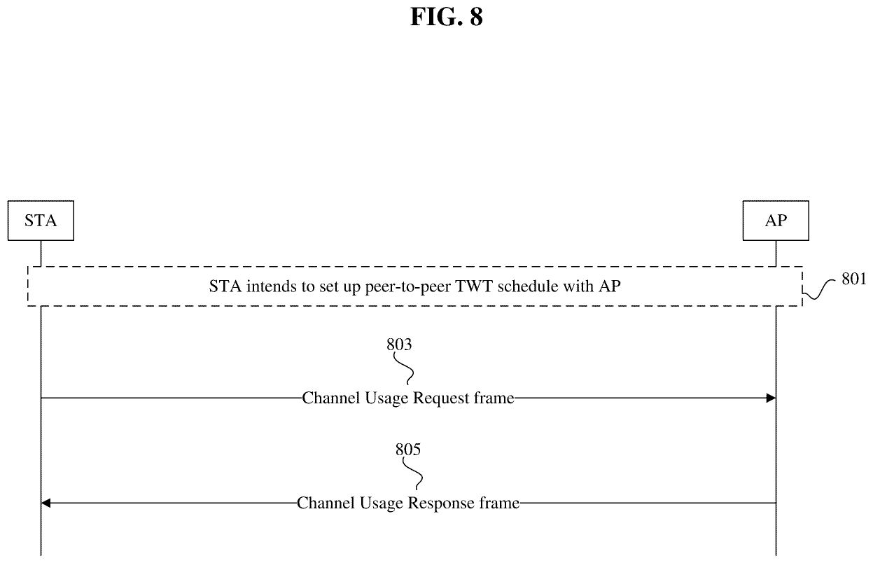

FIG. 8 shows an example channel usage setup communication in accordance with an embodiment. The example depicted in FIG. 8 is for explanatory and illustration purposes. FIG. 8 does not limit the scope of this disclosure to any particular implementation.

Referring to FIG. 8, an AP is associated with an STA. The STA intends to set up a P2P TWT schedule 801 with the AP. The STA transmits, to the AP, a channel usage request frame 803 requesting to establish a P2P TWT schedule 801 with the AP indicating periodic unavailability of the STA. The channel usage request frame 803 includes a channel usage element. The channel usage element includes a usage mode field. In response, the AP transmits, to STA, a channel usage response frame 805 accepting the request to establish the P2P TWT schedule 801. The channel usage response frame 805 includes a channel usage element. The channel usage element includes a usage mode field. The STA and the AP successfully establish the P2P TWT schedule 801 indicating periodic unavailability of the STA.

In an embodiment, a non-AP STA successfully establishes a P2P TWT schedule with an AP indicating periodic unavailability of the non-AP STA. The AP can transmit a TWT teardown frame to the non-AP STA to indicate the termination of a P2P TWT agreement after a lifetime of the P2P TWT schedule ends. The TWT teardown frame includes a TWT flow identifier field of a TWT flow field set to a value equal to a value of a TWT flow identifier field of a channel usage request frame associated with the P2P TWT agreement. After the TWT teardown frame is transmitted the P2P TWT agreement is deleted.

In an embodiment, a non-AP STA successfully establishes a P2P TWT schedule with an AP indicating periodic unavailability of the non-AP STA. The AP can consider that the non-AP STA is in power management mode and in doze state at the beginning of a P2P TWT SP corresponding to the P2P TWT schedule.

In an embodiment, at the end of a P2P TWT SP corresponding to a TWT schedule, an AP can consider a non-AP STA to be in a power management mode that the non-AP STA had been in before entering the P2P TWT SP.

In an embodiment, a non-AP STA can be in active mode right after a P2P TWT SP if the non-AP STA was in active mode right before entering the P2P TWT SP.

In an embodiment, a non-AP STA can be in power save mode right after a P2P TWT SP if the non-AP STA was in power save mode right before entering the P2P TWT SP.

In an embodiment, a non-AP STA can be in doze state right after a P2P TWT SP if the non-AP STA was in a doze state right before the P2P TWT SP.

In an embodiment, a non-AP STA can be in an awake state right after a P2P TWT SP if the non-AP STA was in an awake state right before the P2P TWT SP.

In an embodiment, a non-AP STA is unavailable for communication with the AP during a P2P TWT SP. After the P2P TWT SP ends, the non-AP STA transitions back to a state where the non-AP STA is available for communication with the AP.

In an embodiment, after an unavailability during a P2P TWT SP, when the P2P TWT SP ends, the non-AP STA transitions back to a state it was in before the start of the P2P TWT SP.

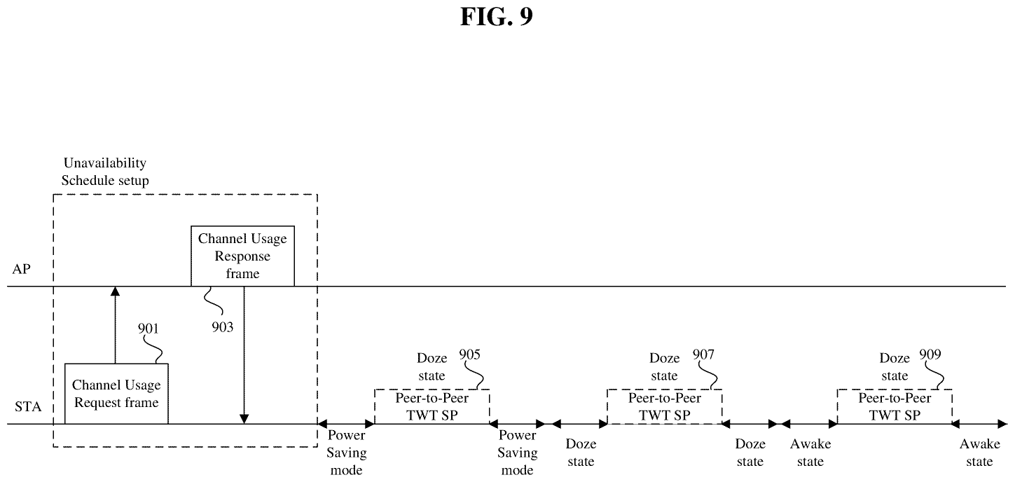

FIG. 9 shows an example power management mode before and after P2P TWT SP in accordance with an embodiment. The example depicted in FIG. 9 is for explanatory and illustration purposes. FIG. 9 does not limit the scope of this disclosure to any particular implementation.

Referring to FIG. 9, an AP is associated with an STA. The STA transmits, to the AP, a channel usage request frame 901 including a TWT elements field. The TWT elements field may include an individual TWT schedule during which the STA expects to be unavailable. In response, the AP transmits, to the STA, a channel usage response frame 903 accepting the request of the channel usage request frame 901. The STA successfully sets up an unavailability schedule, the TWT schedule, with the AP. Prior to the beginning of a P2P TWT SP 905, the STA is in a power save mode and can be in either a doze state or an awake state. The STA switches from an awake state to a doze state or remains in a doze state during the P2P TWT SP 905. After the P2P TWT SP 905 ends, the STA is in a power save mode and in either a doze state or an awake state. Prior to the beginning of a P2P TWT SP 907, the STA is in a doze state. The STA remains in a doze state during the P2P TWT SP 907. After the P2P TWT SP 907 ends, the STA remains in a doze state. Prior to the beginning of a P2P TWT SP 909, the STA is in an awake state. The STA switches from an awake state to a doze state during the P2P TWT SP 909. After the P2P TWT SP 909 ends, the STA switches from a doze state to an awake state.

In an embodiment, an AP associated with a non-AP STA can receive, from the non-AP STA, a frame during a P2P TWT SP where the P2P TWT schedule was successfully established by the non-AP STA with the AP indicating periodic unavailability of the non-AP STA. After receiving the frame, the AP can consider the non-AP STA to be in an awake state for the remaining portion of a P2P TWT SP.

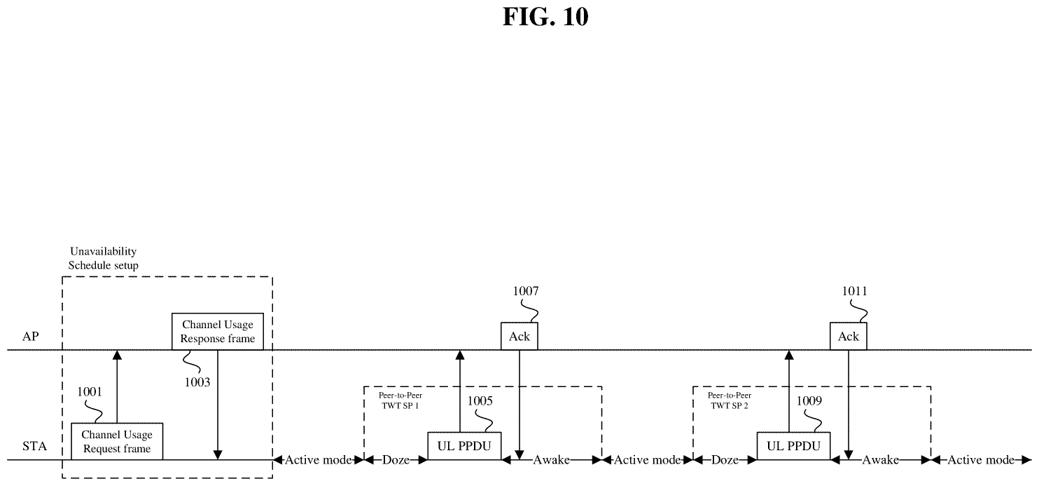

FIG. 10 shows an example power saving state change in accordance with an embodiment. The example depicted in FIG. 10 is for explanatory and illustration purposes. FIG. 10 does not limit the scope of this disclosure to any particular implementation.

Referring to FIG. 10, an AP is associated with an STA. The STA transmits, to the AP, a channel usage request frame 1001 including a TWT elements field. The TWT elements field may include an individual TWT schedule during which the STA expects to be unavailable. In response, the AP transmits, to the STA, a channel usage response frame 1003 accepting the request of the channel usage request frame 1001. The STA successfully sets up an unavailability schedule, the TWT schedule, with the AP. This results in a P2P TWT agreement corresponding to the TWT schedule. Prior to the beginning of a P2P TWT SP 1, the STA is in an active mode and in an awake state. At the start of the P2P TWT SP 1, the STA switches from an awake state to a doze state. Subsequently, during the P2P TWT SP 1, the STA transmits, to the AP, a UL physical layer (PHY) protocol data unit (PPDU) 1005. After receiving the UL PPDU 1005 from the STA, the AP considers the STA to be in an awake state for the remaining duration of the P2P TWT SP 1. In response, the AP transmits, to the STA, an acknowledgement (Ack) frame 1007 acknowledging the UL PPDU 1005. After the P2P TWT SP 1 ends and prior to the beginning of a P2P TWT SP 2, the STA switches to an active mode and remains in an awake state. At the start of the P2P TWT SP 2, the STA switches to a doze state. Subsequently, during the P2P TWT SP 2, the STA transmits, to the AP, a UL PPDU 1009. After receiving the UL PPDU 1009 from the STA, the AP considers the STA to be in an awake state for the remaining duration of the P2P TWT SP 2. In response the AP transmits, to the STA, an Ack frame 1011 acknowledging the UL PPDU 1009. After the P2P TWT SP 2 ends, the STA switches to an Active mode and remains in an awake state.

In FIG. 10, the AP determines that the non-AP STA is in a power save mode and in a doze state at the start of a P2P TWT SP based on the P2P TWT agreement. After the end of the P2P TWT SP, the AP determines that the non-AP STA has transitioned back to a power management mode and a power state that the non-AP STA had been in before entering the P2P TWT SP.

In an embodiment, an AP associated with a non-AP STA can receive, from the non-AP STA, a frame during a P2P TWT SP where the P2P TWT schedule was successfully established by the non-AP STA with the AP indicating periodic unavailability of the non-AP STA. After receiving the frame, the AP can consider the non-AP STA to be in an available state for the remaining portion of a P2P TWT SP. The availability can be for communication with the AP.

In an embodiment, an AP associated with a non-AP STA can receive, from the non-AP STA, a frame during a P2P TWT SP where the P2P TWT schedule was successfully established by the non-AP STA with the AP indicating periodic unavailability of the non-AP STA. After receiving the frame, the AP can consider a power management mode and power state of the non-AP STA based on a portion of information carried in the frame transmitted by the non-AP STA to the AP for the remaining portion of the P2P TWT SP. For example, if the frame transmitted by the non-AP STA indicates that the non-AP STA is in a power save state, then the AP can consider that the non-AP STA is in the power save state for the remaining portion of the P2P TWT SP. For another example, if the frame transmitted by the non-AP STA indicates that the non-AP STA is in an awake state, then the AP can consider that the non-AP STA is in the awake state for the remaining portion of the P2P TWT SP. For yet another example, if the frame transmitted by the non-AP STA indicates that the non-AP STA is in an active state, then the AP can consider that the non-AP STA is in the active state for the remaining portion of the P2P SP.

In an embodiment, a non-AP STA successfully establishes a P2P TWT schedule with an AP associated with the non-AP STA indicating periodic unavailability of the non-AP STA. The AP can receive, from the non-AP STA, a frame during a P2P TWT SP corresponding to the P2P TWT schedule. After receiving the frame, the AP can consider the non-AP STA to be in the same power management mode it was in before entering the P2P TWT SP for the remaining portion of the P2P TWT SP.

In an embodiment, a non-AP STA successfully establishes a P2P TWT schedule with an AP associated with the non-AP STA indicating periodic unavailability of the non-AP STA. The AP can receive, from the non-AP STA, a frame during a P2P TWT SP corresponding to the P2P TWT schedule. After receiving the frame, the AP can consider the non-AP STA to be in a doze state for the remaining portion of the P2P TWT SP.

In an embodiment, a non-AP STA successfully establishes a P2P TWT schedule with an AP associated with the non-AP STA indicating periodic unavailability of the non-AP STA. The AP can receive, from the non-AP STA, a frame during a P2P TWT SP corresponding to the P2P TWT schedule. After receiving the frame, the AP can consider the non-AP STA to be in an active mode for the remaining portion of the P2P TWT SP.

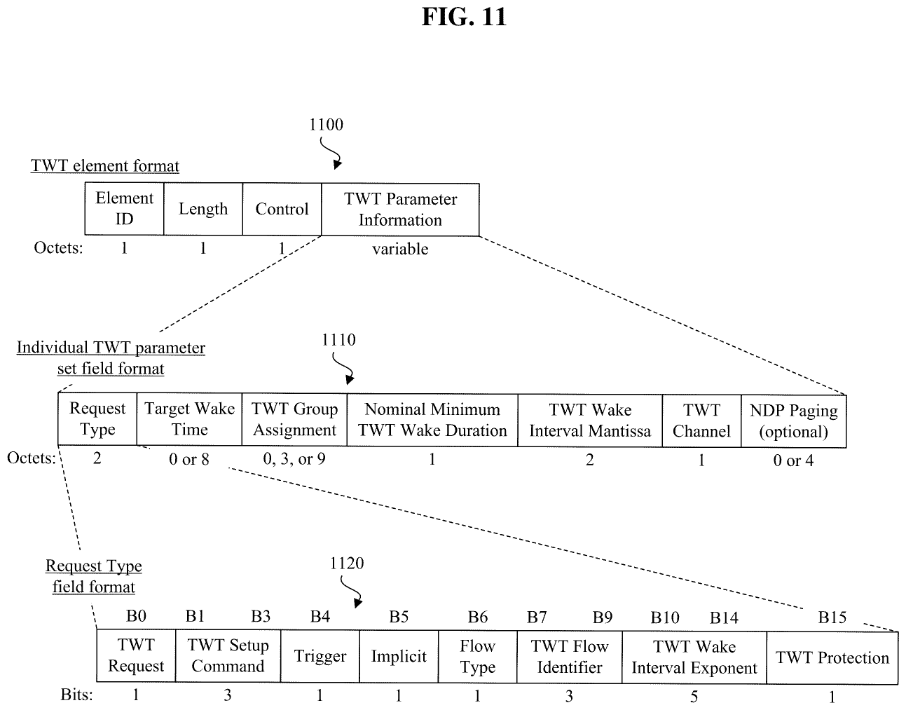

FIG. 11 shows example format of the TWT element in accordance with an embodiment. The example depicted in FIG. 11 is for explanatory and illustration purposes. FIG. 11 does not limit the scope of this disclosure to any particular implementation. In FIG. 11, the TWT element 1100 may include an element ID field, a length field, a control field, and at least one TWT parameter information field. The element ID field may include information to identify the TWT element 1100. The length field may indicate a length of the TWT element 1100. The control field may include various information for interpreting the TWT element 100, for example without limitation, including a null data PPDU (NDP) paging indicator/unavailability mode subfield, a responder power management (PM) mode subfield, a negotiation type subfield, a TWT information frame disabled subfield, a wake duration unit subfield, and reserved bits.

The TWT parameter information field includes an individual TWT parameter set field or one or more broadcast TWT parameter set fields. For the convenience of description, FIG. 11 illustrates the individual TWT parameter set field. The individual TWT parameter set field 1110 may include a request type field, a target wake time field, a TWT group assignment field, a nominal minimum TWT wake duration field, a TWT wake interval mantissa field, a TWT channel field, and an optional NDP paging field.

The request type field 1120 may include a TWT request subfield, a TWT setup command subfield, a trigger subfield, a last broadcast parameter set subfield, a flow type subfield, a broadcast TWT recommendation subfield, a TWT wake interval exponent subfield, and an aligned subfield. The request type field 1120 may be usable for individual TWT operation.

The TWT request subfield may indicate if the transmitting STA is a TWT scheduling STA (AP) or TWT scheduled STA. The TWT setup command subfield may indicate the type of TWT command, such as request TWT, suggest TWT, demand TWT, TWT grouping, accept TWT, alternate TWT, dictate TWT and reject TWT. The trigger subfield may indicate whether the TWT SP indicated by the TWT element includes triggering frames. The implicit subfield may indicate whether the TWT is implicit or explicit. The flow type subfield may indicate the type of interaction, for example, an announced TWT or an unannounced TWT between the TWT scheduled STA and the TWT scheduling AP at TWT. The TWT flow identifier subfield may include information to identify the TWT request from other TWT requests between the TWT scheduled STA and the TWT scheduling AP. For example, the TWT flow identifier subfield may include a 3-bit value that identifies specific information for a TWT request uniquely from other requests made between the same TWT scheduled STA and TWT scheduling AP pair. The TWT wake interval exponent subfield may indicate the value of the exponent of the TWT wake interval value. The TWT protection subfield may indicate a request that the AP provide protection of the set of TWT SPs corresponding to the requested TWT flow identifier.

In an embodiment, a non-AP STA intends to establish a P2P TWT schedule with an AP associated with the non-AP STA. The non-AP STA can transmit a channel usage request frame to the AP including a first TWT element that describes the P2P TWT schedule. After receiving the channel usage request frame from the non-AP STA, the AP can transmit a channel usage response frame to the non-AP STA including a second TWT element that describes the P2P TWT schedule. In an embodiment, a TWT flow identifier field value in the first TWT element in the channel usage request frame can be different from a TWT flow identifier field value in the second TWT element in the channel usage response frame. For example, the AP may choose a TWT flow identifier value in a TWT element carried in the channel usage response frame that is different from the TWT flow identifier value received in the channel usage request frame.

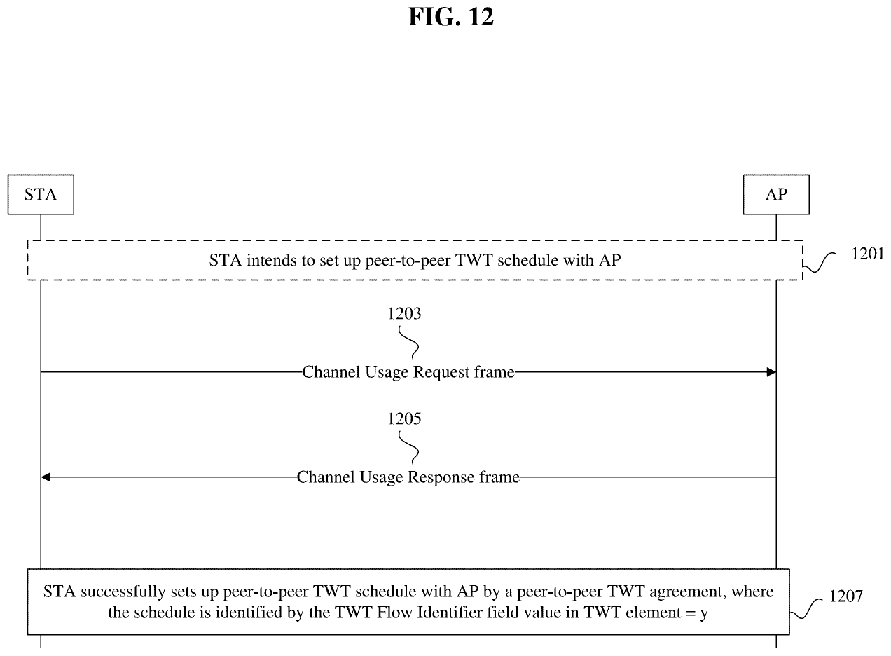

FIG. 12 shows another example channel usage setup communication in accordance with an embodiment. The example depicted in FIG. 12 is for explanatory and illustration purposes. FIG. 12 does not limit the scope of this disclosure to any particular implementation.

Referring to FIG. 12, an AP is associated with an STA. The STA intends to set up a P2P TWT schedule 1201 with the AP. The STA transmits, to the AP, a channel usage request frame 1203 requesting to establish a P2P TWT schedule 1201 with the AP indicating periodic unavailability of the STA. The channel usage request frame 1203 includes a TWT element. The TWT element includes a TWT flow identifier field where the TWT flow identifier field value is set to a value of X. In response, the AP transmits, to STA, a channel usage response frame 1205 accepting the request to establish the P2P TWT schedule 1201. The channel usage response frame 1205 includes a TWT element. The TWT element includes a TWT flow identifier field 1207 where the TWT flow identifier field 1207 value is set to a value Y which is not equal to X. The AP accepting the request to establish the P2P TWT schedule 1201 results in a P2P TWT agreement corresponding to the P2P TWT schedule 1201. The STA and the AP successfully establish a P2P TWT schedule 1201, indicating periodic unavailability of the STA.

In an embodiment, a non-AP STA intends to establish a P2P TWT schedule with an AP associated with the non-AP STA. The non-AP STA can transmit a channel usage request frame to the AP including a first TWT element that describes the P2P TWT schedule. After receiving the channel usage request frame from the non-AP STA, the AP can transmit a channel usage response frame to the non-AP STA including a second TWT element that describes the P2P TWT schedule. In an embodiment, a TWT flow identifier field value in the first TWT element in the channel usage request frame can be the same as a TWT flow identifier field value in the second TWT element in the channel usage response frame. For example, the AP may choose a TWT flow identifier value in a TWT element carried in the channel usage response frame that is the same as the TWT flow identifier value received in the channel usage request frame.

In an embodiment, an AP may not transmit a TWT teardown frame to a non-AP STA to teardown any P2P TWT schedule between them. The AP may not transmit any frame to the non-AP STA to disable or teardown an existing P2P TWT agreement established between the AP and the non-AP STA.

In an embodiment, an AP may transmit a TWT information frame to a non-AP STA to suspend or resume any P2P TWT schedule between them. An AP may not transmit any frame to the non-AP STA to suspend or resume an existing P2P TWT agreement established between the AP and the non-AP STA.

In an embodiment, there can be at most eight P2P TWT agreements established between an AP and a non-AP STA.

In an embodiment, a P2P TWT agreement can be a form of individual TWT agreement.

In an embodiment, the total number of individual TWT agreements including P2P TWT agreements established between a non-AP STA and an AP associated with the non-AP STA cannot exceed 8 because the TWT Flow Identifier field of the TWT element comprises 3 bits.

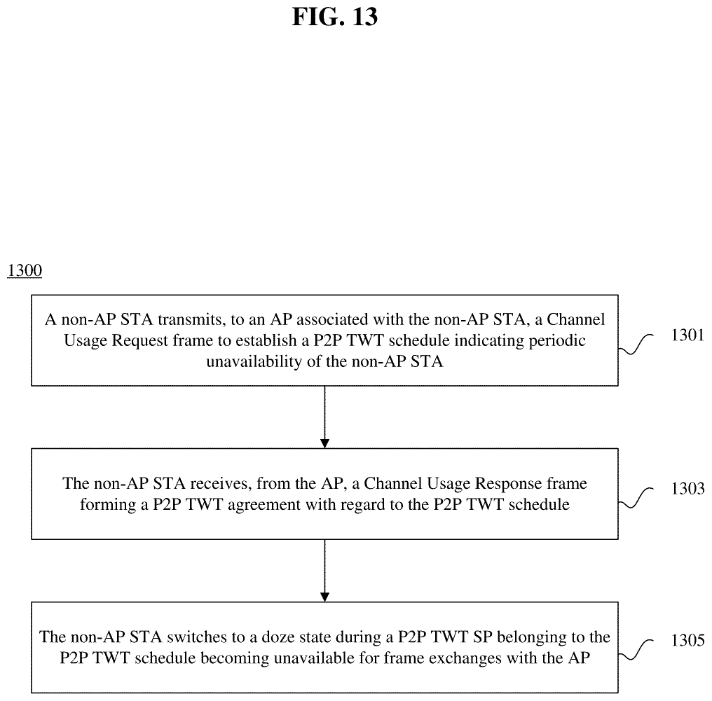

FIG. 13 shows an example process for indicating unavailability in accordance with an embodiment. The process depicted in FIG. 13 is for explanatory and illustration purposes. FIG. 13 does not limit the scope of this disclosure to any particular implementation.

Referring to FIG. 13, the process 1300 begins at operation 1301. In operation 1301, a non-AP STA transmits, to an AP associated with the non-AP STA, a channel usage request frame to establish a P2P TWT schedule indicating periodic unavailability of the non-AP STA. The channel usage request frame includes a channel usage element. The channel usage element includes a usage mode field. The channel usage request frame may include a TWT element. The TWT element may include a TWT flow identifier field.

In operation 1303, the non-AP STA receives, from the AP, a channel usage response frame forming a P2P TWT agreement with regard to the P2P TWT schedule. The channel usage response frame includes a channel usage element. The channel usage element includes a usage mode field. The channel usage response frame may include a TWT element. The TWT element may include a TWT flow identifier field. The TWT flow identifier field of the channel usage response frame may have a value equal to the TWT flow identifier field of the channel usage request frame. The TWT flow identifier field of the channel usage response frame may have a value different from the TWT flow identifier field of the channel usage request frame.

In operation 1305, the non-AP STA switches to a doze state during a P2P TWT SP belonging to the P2P TWT schedule becoming unavailable for frame exchanges with the AP. After the P2P TWT SP ends, the non-AP STA can switch to a mode or state that the non-AP STA was in just prior to the P2P TWT SP.

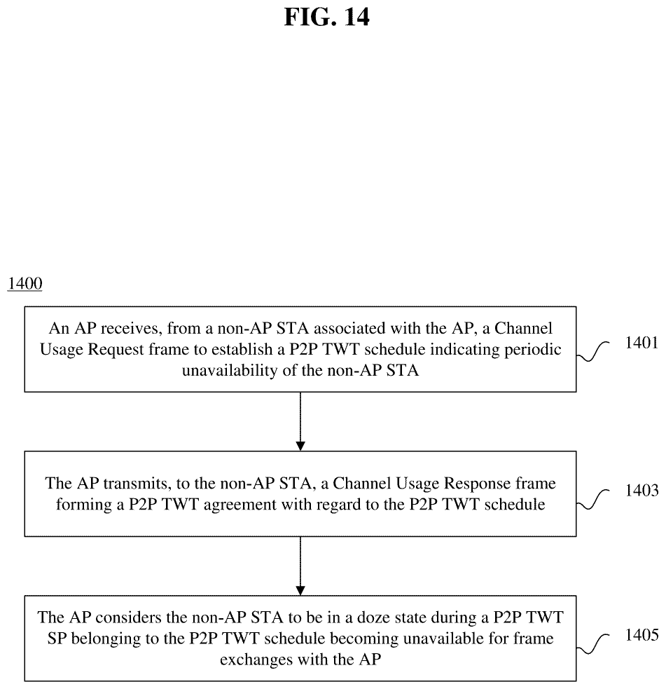

FIG. 14 shows another example process for indicating unavailability in accordance with an embodiment. The process depicted in FIG. 14 is for explanatory and illustration purposes. FIG. 14 does not limit the scope of this disclosure to any particular implementation.

Referring to FIG. 14, the process 1400 begins at operation 1401. In operation 1401, an AP receives, from a non-AP STA associated with the AP, a channel usage request frame to establish a P2P TWT schedule indicating periodic unavailability of the non-AP STA. The channel usage request frame includes a channel usage element. The channel usage element includes a usage mode field. The channel usage request frame may include a TWT element. The TWT element may include a TWT flow identifier field.

In operation 1403, the AP transmits, to the non-AP STA, a channel usage response frame forming a P2P TWT agreement with regard to the P2P TWT schedule. The channel usage response frame includes a channel usage element. The channel usage element includes a usage mode field. The channel usage response frame may include a TWT element. The TWT element may include a TWT flow identifier field. The TWT flow identifier field of the channel usage response frame may have a value equal to the TWT flow identifier field of the channel usage request frame. The TWT flow identifier field of the channel usage response frame may have a value different from the TWT flow identifier field of the channel usage request frame.

In operation 1405, the AP considers the non-AP STA to be in a doze state during a P2P TWT SP belonging to the P2P TWT schedule becoming unavailable for frame exchanges with the AP.

The disclosure provides mechanisms and protocols for indicating periodic unavailability of STA devices in channel usage. This prevents AP devices from trying to perform frame exchanges with a STA device that is periodically unavailable. AP devices can thereby save power during the periodic unavailability of STA devices. This saving of power provides improving power efficiency of channel usage.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) for facilitating communication in a wireless network, comprising:
a memory; and
a processor coupled to the memory, the processor configured to cause:
receiving, from a non-AP station (STA) associated with the AP, a channel usage request frame requesting to establish a peer-to-peer (P2P) target wake time (TWT) agreement, the channel usage request frame indicating the non-AP STA's unavailability during the P2P TWT agreement;
transmitting, to the non-AP STA, a channel usage response frame accepting the request to establish a P2P TWT agreement; and
determining that the non-AP STA is in a power save mode and in a doze state at a start of a P2P service period associated with the P2P TWT agreement and the non-AP STA transitions back to a power management mode that the non-AP STA had before entering the P2P service period.

2. The AP of claim 1, wherein the processor is further configured to cause:
receiving, from the non-AP STA, a frame that is addressed to the AP within a time that overlaps with the P2P TWT service period; and
determining a power management mode and a power state of the non-AP STA for a remaining portion of the P2P TWT service period based on information carried in the frame.

3. The AP of claim 1, wherein the channel usage request frame includes a usage mode field in a channel usage element, the usage mode field indicating the non-AP STA's unavailability during the P2P TWT agreement.

4. The AP of claim 1, wherein the channel usage response frame includes a usage mode field in a channel usage element, the usage mode field indicating the non-AP STA's unavailability during the P2P TWT agreement.

5. The AP of claim 1, wherein a value for a TWT flow identifier field in a TWT element in the channel usage response frame is different from a value of a TWT flow identifier field in a TWT element in the channel usage request frame, each TWT flow identifier field indicating information to identify the P2P TWT agreement.

6. The AP of claim 1, wherein a value for a TWT flow identifier field in a TWT element in the channel usage response frame is different from a value of a TWT flow identifier field in a TWT element in the channel usage request frame, each TWT flow identifier field indicating information to identify a different P2P TWT agreement.

7. The AP of claim 1, wherein a value for a TWT flow identifier field in a TWT element in the channel usage response frame is the same as a value of a TWT flow identifier field in a TWT element in the channel usage request frame, each TWT flow identifier field indicating information to identify the P2P TWT agreement.

8. The AP of claim 1, wherein the processor is further configured to cause:
abstaining from transmitting a TWT teardown frame to a non-AP STA requesting to delete the P2P TWT agreement.

9. The AP of claim 1, wherein the processor is further configured to cause:
abstaining from transmitting a TWT information frame to a non-AP STA requesting to suspend or resume the P2P TWT agreement.

10. The AP of claim 1, wherein:
the P2P TWT agreement is an individual TWT agreement; and
a number of individual TWT agreements established between the AP and the non-AP STA is not greater than a value indicated by a TWT flow identifier field in a TWT element in the channel usage request frame or the channel usage response frame.

11. A non-access point (AP) station (STA) for facilitating communication in a wireless network, comprising:
a memory; and
a processor coupled to the memory, the processor configured to cause:
transmitting, to an AP associated with the non-AP STA, a channel usage request frame requesting to establish a peer-to-peer (P2P) target wake time (TWT) agreement, the channel usage request frame indicating the non-AP STA's unavailability during the P2P TWT agreement;
receiving, from the AP, a channel usage response frame accepting the request to establish a P2P TWT agreement;
entering a P2P service period associated with the P2P TWT agreement in a power save mode and in a doze state; and
transitioning back to a power management mode that the non-AP STA had before entering the P2P service period.

12. The non-AP STA of claim 11, wherein the processor is further configured to cause:
transmitting, to the AP, a frame that is addressed to the AP within a time that overlaps with the P2P TWT service period; and
transitioning to a power management mode and a power state for a remaining portion of the P2P TWT service period.

13. The non-AP STA of claim 11, wherein the channel usage request frame includes a usage mode field in a channel usage element, the usage mode field indicating the non-AP STA's unavailability during the P2P TWT agreement.

14. The non-AP STA of claim 11, wherein the channel usage response frame includes a usage mode field in a channel usage element, the usage mode field indicating the non-AP STA's unavailability during the P2P TWT agreement.

15. The non-AP STA of claim 11, wherein a value for a TWT flow identifier field in a TWT element in the channel usage response frame is different from a value of a TWT flow identifier field in a TWT element in the channel usage request frame, each TWT flow identifier field indicating information to identify the P2P TWT agreement.

16. The non-AP STA of claim 11, wherein a value for a TWT flow identifier field in a TWT element in the channel usage response frame is different from a value of a TWT flow identifier field in a TWT element in the channel usage request frame, each TWT flow identifier field indicating information to identify a different P2P TWT agreement.

17. The non-AP STA of claim 11, wherein a value for a TWT flow identifier field in a TWT element in the channel usage response frame is the same as a value of a TWT flow identifier field in a TWT element in the channel usage request frame, each TWT flow identifier field indicating information to identify the P2P TWT agreement.

18. The non-AP STA of claim 11, wherein the processor is further configured to cause:
abstaining from transmitting a TWT teardown frame to a non-AP STA requesting to delete the P2P TWT agreement.

19. The non-AP STA of claim 11, wherein the processor is further configured to cause:
abstaining from transmitting a TWT information frame to a non-AP STA requesting to suspend or resume the P2P TWT agreement.

20. The non-AP STA of claim 11, wherein:
the P2P TWT agreement is an individual TWT agreement; and
a number of individual TWT agreements established between the AP and the non-AP STA is not greater than a value indicated by a TWT flow identifier field in a TWT element in the channel usage request frame or the channel usage response frame.
